(19) United States
(12) Patent Application Publication
(10) Pub. No.: US 2007/0277652 A1
(43) Pub. Date: Dec. 6, 2007

(54) Reversible ratcheting tool

(76) Inventor: Hsien-Chung Tuan-Mu, Taiwan (TW)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/443,399

(22) Filed: May 30, 2006

(51) Int. Cl. B25B 13/46

(52) U.S. Cl. 81/63; 81/63.2

(57) ABSTRACT

A reversible ratchet wrench includes a handle with a drive head that defmes a drive aperture and a through bore located adjacent thereto. A retaining recess slidably receives a pawl including drive teeth and a control recess. A direction control member is rotatably mounted in the through bore. A pressing member is mounted between the direction control member and the control recess of the pawl, and a ratchet wheel is rotatably received in the drive aperture. The ratchet wheel includes a first end having a first driving cavity, a second end having a second driving cavity, and a central portion disposed therebetween. The first and second ends of the ratchet wheel extend beyond opposing surfaces of the drive head, and the central portion of the ratchet wheel has an outer diameter that is greater than the outer diameters of the first and second ends.

### FIELD OF THE INVENTION

The present invention relates generally to reversible ratcheting tools. More particularly, the present invention relates to reversible ratcheting wrenches that can engage fasteners of multiple sizes.

### BACKGROUND OF THE INVENTION

Ratcheting wrenches are known that are capable of engaging two different sized fasteners. A ratchet wrench may be, for example, capable of engaging a ⅞ inch fastener with one end of the wrench and a ½ inch fastener at the opposite end of the wrench handle. Thus, the number of wrenches required to insure a user can engage a given number of differently sized fasteners is reduced by half.

Ratchet wrenches are often used to engage fasteners in areas that are hard to reach, such as in the engine compartment of an automobile. Therefore, it is often desirable to reverse the direction in which the wrench will ratchet without having to remove it from the fastener.

### SUMMARY OF THE INVENTION

The present invention recognizes and addresses considerations of prior art constructions and methods.

One embodiment of the present invention provides a reversible ratchet wrench including a handle having a drive head at a first end thereof that defines a drive aperture and a through bore located adjacent to the drive aperture. A retaining recess is intermediate and in communication with the drive aperture and the through bore. A pawl including a first plurality of drive teeth on a first side and a control recess in a second side is slidably received in the retaining recess. A direction control lever is mounted in the through bore and movable between a first predetermined position and a second predetermined position. A pressing member is mounted between the direction control lever and the control recess of the pawl and a ratchet wheel is rotatably received in the drive aperture. The ratchet wheel includes a first end having a first recess defining a first driving cavity, a second end having a second recess defining a second driving cavity, and a central portion disposed therebetween including a second plurality of drive teeth configured to engage the first plurality of drive teeth. The first and second recesses form a through hole along a longitudinal center axis of the ratchet wheel. The first end of the ratchet wheel extends outwardly beyond a top surface of the drive head, the second end extends outwardly beyond a bottom surface of the drive head, and the central portion of the ratchet wheel has an outer diameter that is greater than an outer diameter of the first end and an outer diameter of the second end.

A second embodiment of the invention provides a reversible ratchet wrench including a handle having a drive head at a first end thereof that defmes a drive aperture and a through bore located adjacent to the drive aperture. A retaining recess is in communication with the drive aperture and the through bore. A pawl including a first plurality of drive teeth on a first side and a control recess formed on a second side is slidably received in the retaining recess. A direction control lever is mounted in the through bore and is movable between a first predetermined position and a second predetermined position. A detent pin is reciprocally received in the direction control member and is biased into contact with the control recess of the pawl. A ratchet wheel is rotatably received in the drive aperture and includes a first end having a first recess defining a first driving cavity and a second driving cavity, a second end having a second recess defining a third driving cavity, and a central portion disposed therebetween including a second plurality of drive teeth configured to engage the first plurality of drive teeth, the first and second recesses forming a through hole along a longitudinal center axis of the ratchet wheel. The second driving cavity is disposed farther from a central longitudinal axis of the handle than is the first driving cavity.

The accompanying drawings, which are incorporated in and constitute a part of this specification, illustrate one or more embodiments of the invention and, together with the description, serve to explain the principles of the invention.

### BRIEF DESCRIPITION OF THE DRAWINGS

A full and enabling disclosure of the present invention, including the best mode thereof, directed to one of ordinary skill in the art, is set forth in the specification, which makes reference to the appended drawings, in which:

FIG. 1 is an exploded, partial perspective view of a reversible ratchet wrench in accordance with an embodiment of the present invention;

FIG. 2 is a partial cross-sectional assembly view of the reversible ratchet wrench as shown in FIG. 1;

FIGS. 3A through 3C are top, side and bottom views, respectively, of the ratchet wrench as shown in FIG. 1;

FIGS. 4A through 4C are partial cross-sectional operational views of the reversible ratchet wrench as shown in FIG. 1;

FIG. 5 is a perspective cross-sectional view of a ratchet wheel in accordance with an embodiment of the present invention;

FIG. 6 is a perspective cross-sectional view of a ratchet wheel in accordance with an embodiment of the present invention;

FIGS. 7A and 7B are a perspective cross-sectional view and a top view, respectively, of a ratchet wheel in accordance with an embodiment of the present invention;

FIG. 8 is a partial cross-sectional view of a reversible ratchet wrench including a ratchet wheel as shown in FIGS. 7A and 7B;

FIGS. 9A through 9C are a perspective cross-sectional view, a bottom view, and a top view, respectively, of a ratchet wheel in accordance with an embodiment of the present invention;

FIG. 10 is a partial cross-sectional view of a reversible ratchet wrench including a ratchet wheel as shown in FIGS. 9A through 9C; and

FIG. 11 is a perspective view of the pawl as shown in FIG. 1.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

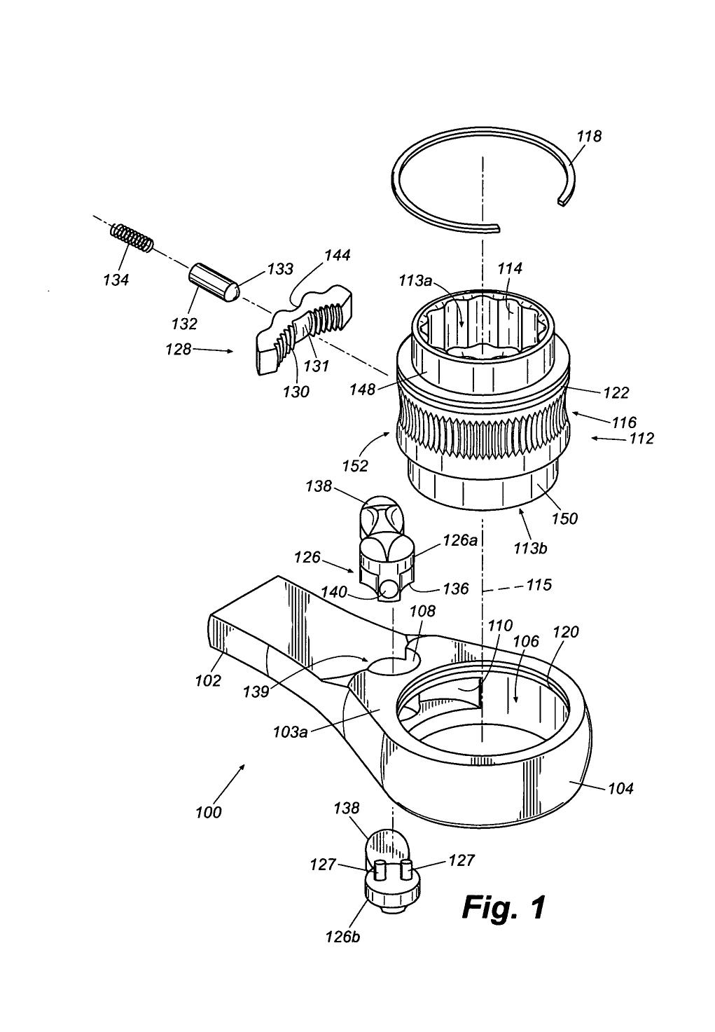

Referring now to FIGS. 1, 2 and 3A through 3C, a reversible ratchet wrench 100 in accordance with an embodiment of the present invention includes a handle 102 made of a solid, homogeneous metal (e.g. Cr—Mn alloy steel) forging having an enlarged driving head 104 and defining three compartments—a drive aperture 106, an open through bore 108 located adjacent to drive aperture 106, and a retaining recess 110 defined in a side wall of drive aperture 106 and connecting to open through bore 108. A drive wheel, or ratchet wheel 112, is rotatably secured in drive aperture 106 and has an inner wall defining at least one driving cavity 114 and an outer wall provided with an annular array of drive teeth 116. A C-shaped snap ring 118 is received in an annular groove 120 formed in the inner wall of drive aperture 106 and in an annular groove 122 formed in the outer surface of ratchet wheel 112, thereby securing ratchet wheel 112 in drive aperture 106.

As shown, ratchet wheel 112 includes a first end 148 and a second end 150 extending outwardly from a central portion 152 about the circumference of which drive teeth 116 are defined. First end 148 includes a first recess 113a and second end 150 includes a second recess 113b, the first and second recesses being in communication with each other so that they form a through hole along a longitudinal center axis 115 of ratchet wheel 112. An inner circumference of ratchet wheel 112 at driving cavity 114 defmes a series of spaced apart drive shoulders aligned axially with respect to center axis 115 of the ratchet wheel and the drive aperture. The dimensions of the recess 113a and the drive shoulders are such that the drive shoulders drivingly engage a fastener head of a predetermined size (the diameter across opposing vertical drive shoulders in a cavity such as cavity 113a that defines the size of the fastener the cavity is configured to receive through its recess and drive is referred to herein as the “operative diameter”). The operative diameter of driving cavity 114 is different from the operative diameter of the driving cavity (not shown) defined at recess 113b, and the same ratchet wheel 112 can therefore be used to drive fastener heads of two different sizes.

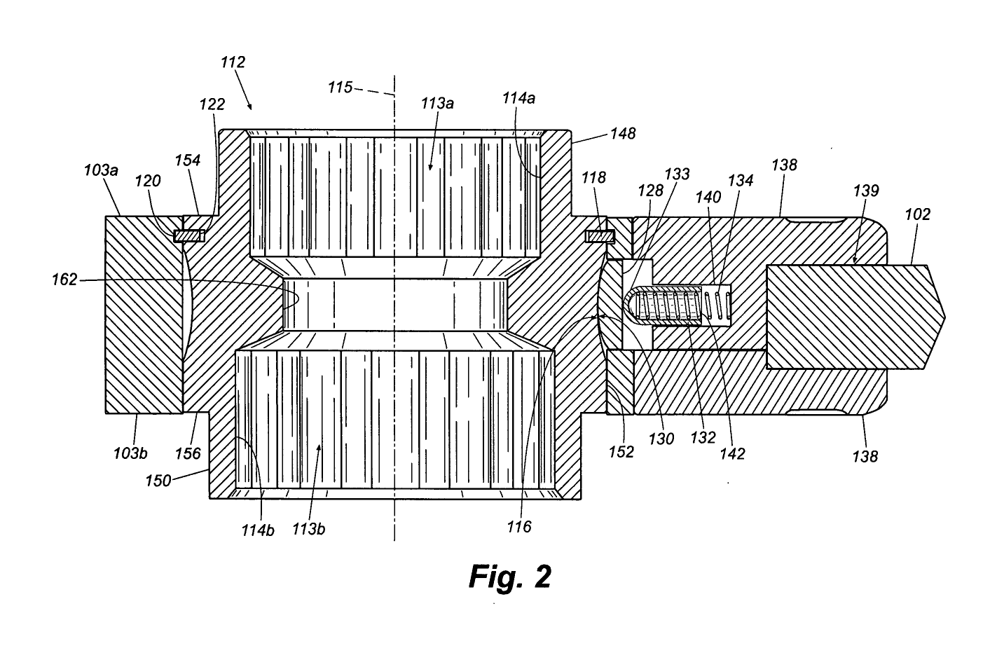

As best seen in FIG. 2, the outer diameter of central portion 152 is greater than the outer diameters of both first end 148 and second end 150. As well, both first end 148 and second end 150 of ratchet wheel 112 extend outwardly beyond their respective opposed surfaces 103a and 103b of drive head 104. Inwardly depending ledges 154 and 156 connect first end 148 and second end 150, respectively, to central portion 152. First and second ledges 154 and 156 are generally co-planer with their respective opposed surface 103a and 103b, of drive head 104. The reduced outer diameters of first and second ends 148 and 150 of ratchet wheel 112, relative to the diameter of central portion 152, facilitate reaching fasteners in tight locations. The relatively larger diameter of central portion 152, and therefore the relatively larger diameter of the circle on which drive teeth 116 are defined, permit a greater number of, and/or stronger, teeth than would generally be possible if central portion 152 was of the same diameter as first or second end 148 or 150. Increasing the number of drive teeth 116 allows for a wrench that has a smoother ratcheting action when compared to an embodiment with fewer teeth.

First recess 113a includes a first driving cavity 114a, and second recess 113b includes a second driving cavity 114b, the driving cavities being separated by a radially inwardly depending ledge 162. Ledge 162 assists in seating the fastener head in the desired drive cavity and provides an abutment such that a fastener being engaged by the smaller drive cavity 113a cannot inadvertently pass through to the larger drive cavity 113b.

A direction control mechanism is mounted in handle 102 and includes a direction control member (including, in the illustrated embodiments, a lever 126 rotatably mounted in through bore 108), a pawl 128 pivotally mounted in retaining recess 110, a pressing member (preferably, an elongated pin 132) mounted between direction control lever 126 and pawl 128, and a biasing member (preferably, a spring 134) mounted between direction control lever 126 and pin 132 for urging the pin against pawl 128. Pawl 128 has a first side provided with a plurality of drive teeth 130 meshing with the annular array of drive teeth on ratchet wheel 112 and a second side opposite the first side and defining a control recess 144 that receives pin 132.

Referring also to FIG. 1, direction control lever 126 includes a first portion 126a and a section portion 126b. First portion 126a includes a generally cylindrical body 136 rotatably mounted in through bore 108 and a hand-actuatable handle portion 138 extending outward from the body portion generally parallel to body 102 for rotating body portion 136 in and about the axis of through bore 108. Body portion 136 of direction control lever 126 defines a first blind bore 140 for receiving detent pin 132 therein, and detent pin 132 defines a second blind bore 142 (FIG. 2) for receiving spring 134, which is biased between the wall of first blind bore 140 and the wall of second blind bore 142. As such, detent pin 132 is reciprocally secured in the first blind bore of direction control lever 126 and is biased outward from the first blind bore so that an end of the pin abuts the second side of pawl 128 and slides on the second side of pawl 128 to switch the pawl's position in recess 110. Second portion 126b of the direction control member also includes a hand actuatable handle portion 138 extending outwardly from a generally cylindrical rotating body 136 that is pivotally received in through bore 108. Lower portion 126b includes a pair of pins 127 that are received in corresponding bores (not shown) of upper portion 126a to rotationally secure the upper end and lower portions to each other. Preferably the bores in upper portion 126a receive pins 127 in an interference fit, so that as pins 127 are pushed into the bores, a resulting wedge between the pins and the bores retains the upper and lower portions together in the axial direction. It should be understood, however, that other mechanisms for retaining the upper and lower portions together, for example as disclosed in U.S. Pat. No. 6,918,477, issued Jul. 19, 2005, (the entire disclosure of which is incorporated by reference herein) are encompassed by the scope of the present invention. Handle portions 138 extend along opposing surfaces of handle 102, and each is pivotably received in a respective lever recess 139 formed in drive head 104.

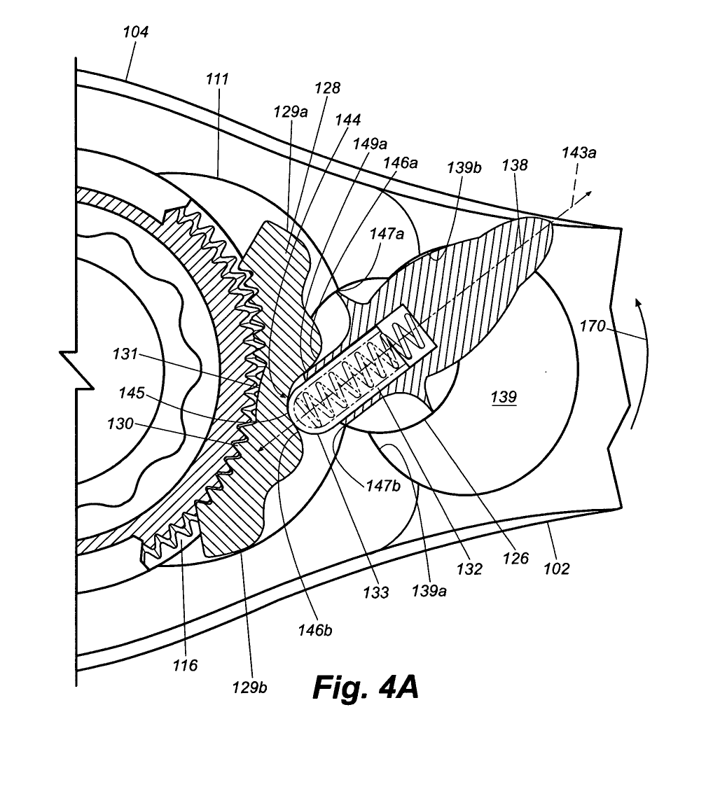

As best seen in FIGS. 4A through 4C, detent pin 132 includes an arcuate head 133, and the second side of pawl 128 defines arcuate control recess 144 for receiving detent pin head 133. Control recess 144 of the pawl 128 has a curved mediate portion 145 that limits movement of detent pin head 133. Mediate portion 145 has two ends provided with respective end walls 146a and 146b. Preferably, curved mediate portion 145 defines a shape that is substantially complimentary to the outer shape of detent pin head 133. More specifically, and referring to FIG. 4B, consider a first plane 137 that includes the axis 115 (FIG. 1) of drive aperture 106 and the axis of pin 132 and a second plane 141 normal to plane 137 and tangent to the tip of pin 132 and the bottom of recess 144. Each end wall 146a and 146b extends proximate to the pin and away from the bottom of recess 144 (in the direction away from the first side of pawl 128) into a respective area between the first and second planes so that when a user rotates lever 126 about the axis of hole 139 in one direction or the other, the tip of pin 132 slides up on either end wall 146a or 146b (depending on the lever's rotational direction). The pin pushes pawl 128 at the end wall to the corresponding side in recess 110 until pawl 128 stops in a position in which the pawl's first side engages ratchet teeth 116, its second side engages a wall of recess 110, and the axis of pin 132 aligns with the pawl's ratcheting directions 143a (FIG. 4A) or 143b (FIG. 4C). The configuration of end walls 146a and 146b, and the length of pawl 128, are such that the pawl reaches the stopped position before pin 132 engages a corner 147a or 147b at which recess 110 and through bore 108 intersect. Thus, the total angle through which lever 132 must be rotated in order to move pawl 128 from one side of retaining recess 110 to the other is reduced.

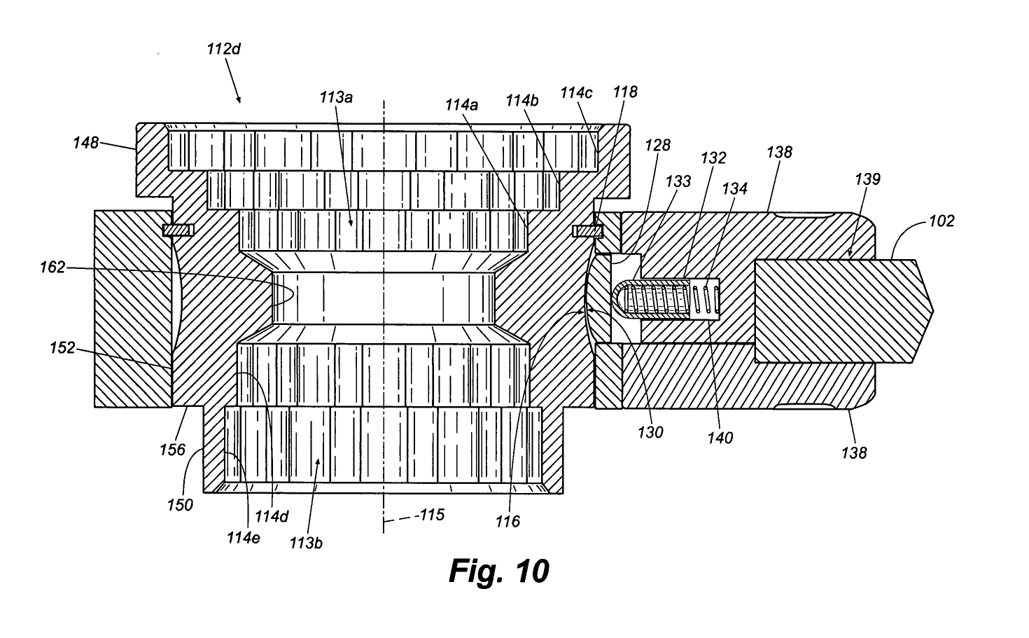

As best seen in FIG. 11, the first side of pawl 128 defines a mediate portion provided with an arcuate support portion 131 located between opposing sections of first drive teeth 130. Control recess 144 of pawl 128 has a width greater than that of support portion 131 of pawl 128 so that when head 133 of detent pin 132 is moved from one end wall 146a, 146b to the other in control recess 144, pawl 128 is pivoted about support portion 131. The pivoting of pawl 128 causes one of either end portions 129a and 129b of pawl 128 to be urged against a curved retaining wall 111 of retaining recess 110. The construction of the front face of the pawl is not, in and of itself, part of the present invention, and it should be understood that the pawl may be configured as desired, e.g. as shown in U.S. Pat. Nos. 6,629,477 and 6,918,323, the entire disclosure of which is incorporated by reference herein.

In operation, when either the upper or lower handle 138 of direction control lever 126 is disposed in the position as shown in FIG. 4B, head 133 of detent pin 132 rests on mediate portion 145 of control recess 144 and biases the pawl toward the ratchet wheel so that support portion 131 of pawl 128 abuts drive teeth 116 of ratchet wheel 112. The opposed sections of drive teeth 130 at the two ends of pawl 128 are slightly detached from drive teeth 116.

When the user turns handle 138 from the position as shown in FIG. 4B to the position as shown in FIG. 4A, detent pin 132 is rotated with lever body 136 such that head 133 moves in control recess 144 from mediate portion 145 into contact with end wall 146b. So positioned, detent pin 132 urges end wall 146b of pawl 128 toward ratchet wheel 112. Pawl 128 therefore pivots about support portion 131 so that the section of drive teeth 130 at a first end 129b of pawl 128 engages with ratchet wheel drive teeth 116.

In this configuration, when handle 102 of ratchet wrench 100 is rotated in the counter-clockwise direction 170 as shown in FIG. 4A, arcuate end portion 129b of pawl 128 is received and pressed between retaining wall 111 of retaining recess 110 and the outer wall of ratchet wheel 112 so that arcuate end portion 129b of pawl 128, retaining wall 111 of retaining recess 110, and the outer wall of ratchet wheel 112 cooperate with each other to form a tight fit engagement as shown in FIG. 4A and transfer torque in the clockwise direction from handle 102 to a workpiece (e.g. a polygonal fastener head, not shown) received by the ratchet wheel.

As shown in FIG. 4A, when head 133 of detent pin 132 engages end wall 146b so that the axis of pin 132 is aligned in the pawl's ratcheting direction 143a, end wall 146a contacts the front portion of lever bore side wall 149a, and handle 138 abuts a first wall 139b of lever recess 139 formed in drive head 104. The engagement between handle 138 and first wall 139b limits the lever's counter-clockwise rotation to the position in which the pin is aligned in the pawl's ratcheting direction 143a, thereby facilitating effective transition of force from the pawl to the pin and spring when the pawl ratchets as handle 102 is rotated in the clockwise direction while the ratchet wheel is secured on a workpiece. As handle 102 is turned in counterclockwise direction 170 while ratchet wheel 112 is secured to a workpiece, pawl 128 may tend to pivot in recess 110 in the clockwise direction, thereby concentrating force on the teeth at the end of the pawl's front face. Because handle 138 stops the lever's rotation in the counterclockwise direction, the engagement of end wall 146a with the front portion of lever bore side wall 148a inhibits such clockwise rotation by the pawl and maintains alignment of the pin axis with the pawl's ratcheting direction 143a.

Alternatively, when the user wishes to change the driving direction of ratchet wrench 100, either handle 138 of direction control lever 126 is moved from the position as shown in FIG. 4A to the position as shown in FIG. 4C. In so doing, detent pin 132 is rotated with body 136 of direction control lever 126 such that head 133 moves in control recess 144 from end wall 146b to end wall 146a at the opposite end of the control recess 144. This urges end wall 146a toward ratchet wheel 112, and pawl 128 therefore pivots about support portion 131 so that the section of drive teeth 130 at a second 129a end of pawl 128 engages drive teeth 116 of ratchet wheel 112.

In this configuration, when handle 102 of ratchet wrench 100 is rotated in the clockwise direction 172 shown of FIG. 4C, arcuate end portion 129a of pawl 128 is received and pressed between retaining wall 111 of retaining recess 110 and the outer wall of ratchet wheel 112 so that arcuate end portion 129a of pawl 128, retaining wall 111 of retaining recess 110, and the outer wall of ratchet wheel 112 cooperate with each other to form a tight fit engagement as shown in FIG. 4C and transfers torque in the counterclockwise direction from handle 102 to a workpiece (not shown) received by the ratchet wheel.

Similarly to the position shown in FIG. 4A, when handle 138 is positioned as shown in FIG. 4C, engagement of handle 138 with lever recess second wall 139a prevents the lever's over-rotation beyond a position in which the axis of pin 132 is aligned with the pawl's ratcheting direction 143b. As well, since end wall 146b abuts the front portion of bore side wall 149b, pawl 128 is also prevented from pivoting away from the ratchet wheel in the counterclockwise direction as torque is applied in a clockwise direction 172. As shown in FIGS. 4A and 4C, a sufficient gap exists between pawl first wall 146a and pawl second wall 146b and direction control lever 126, respectively, such that proper ratcheting action of pawl 128 relative to direction control lever 126 occurs in directions 143a and 143b when rotating handle 102 in the clockwise and counterclockwise directions, respectively.

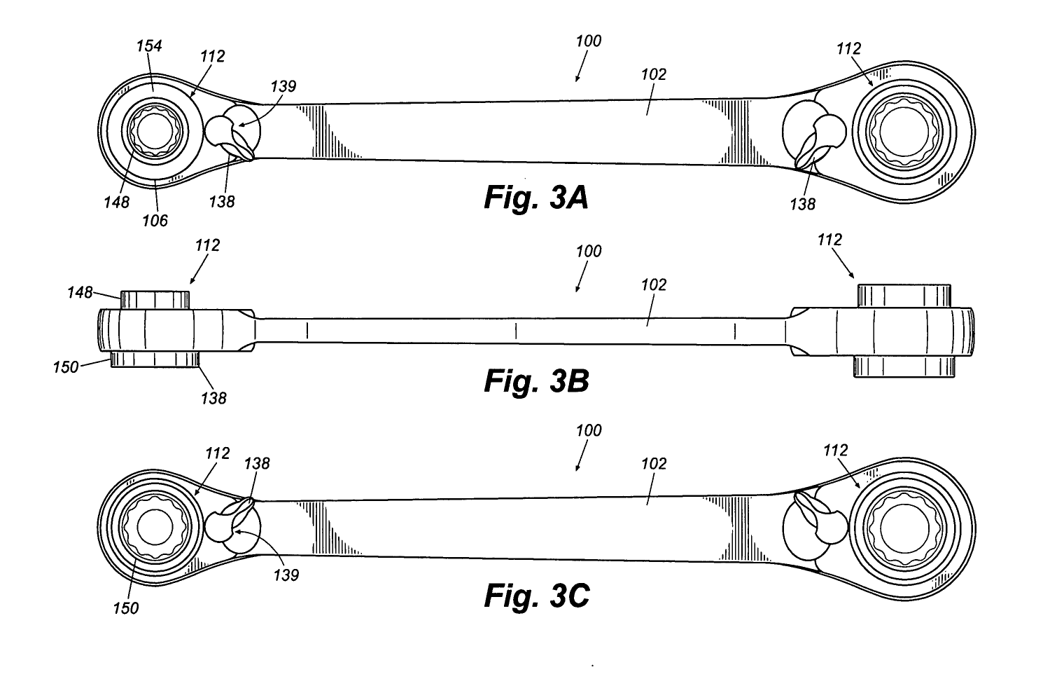

Preferably a similarly constructed second ratchet wheel is received in the drive aperture in a driving head on the opposite side of the wrench handle (as in FIGS. 3A through 3C), where each of the two operative diameters in the second ratchet wheel is different from each other and from the two cavity operative diameters in ratchet wheel 112b, so that the same wrench 100 may be used with any of four differently sized fastener heads.

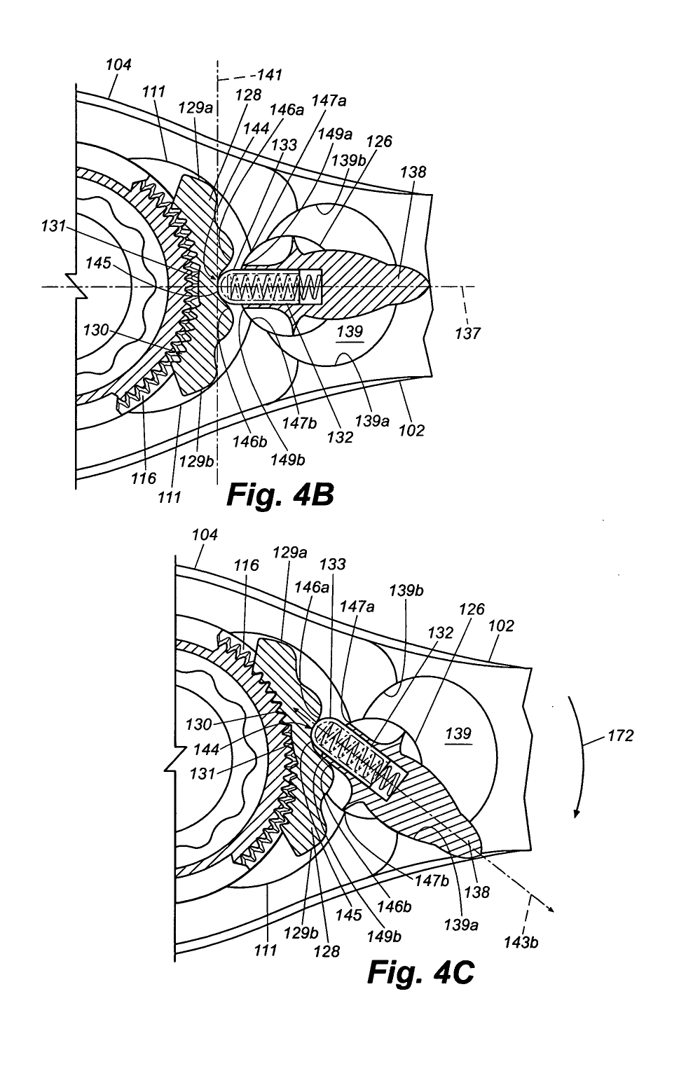

FIG. 5 illustrates a ratchet wheel 112a for use with a ratchet wrench according to a further embodiment of the present invention. Ratchet wheel 112a includes a first drive cavity 114a formed in first end 148 and a second drive cavity 114b formed in second end 150.

Unlike ratchet wheel 112 shown in FIG. 2, first and second drive cavities 114a and 114b of ratchet wheel 112a are contiguous (that is, the cavities as defined by the respective gripping surfaces open into each other in the axial direction without separation by an intervening ledge or other intermediate structure). Because first and second drive cavities 114a and 114b have different operative diameters so that they may engage different sized fastener heads, a ledge 164 extends outwardly between the contiguous ends of the drive cavities. Ledge 164 acts as an abutment only to those fasteners being engaged with first drive cavity 114a.

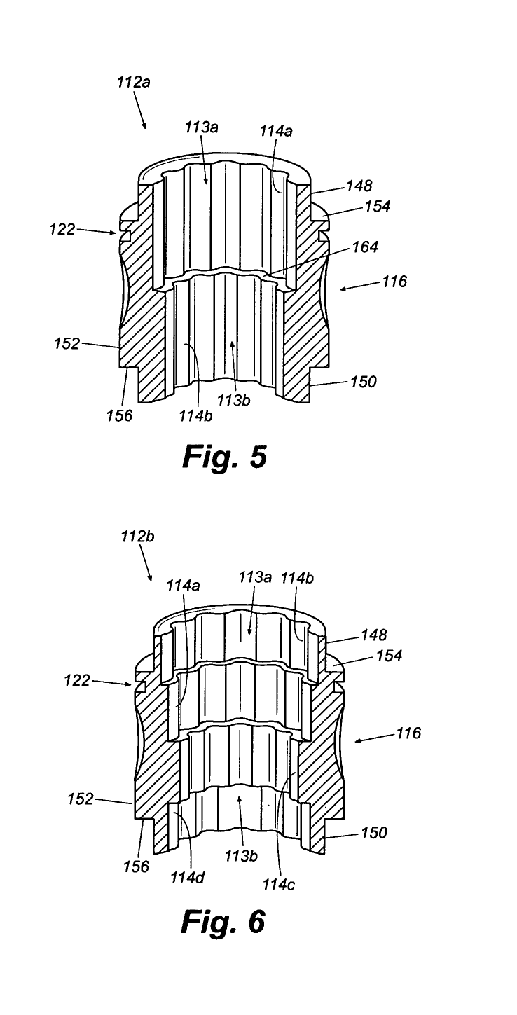

FIG. 6 illustrates a ratchet wheel 112b for use with a ratchet wrench in accordance with a still further embodiment of the present invention. Similar to ratchet wheel 112a as shown in FIG. 5, ratchet wheel 112b includes contiguous first and second recesses 113a and 113b. First recess 113a, however, defines two drive cavities 114a and 114b, each defining a different operative diameter such that cavities 114a and 114b are configured to receive and drive differently sized fastener heads. Similarly, second recess 113b defines differently sized drive cavities 114c and 114d.

Each of cavities 114a-114d defines a different operative diameter, with the cavities decreasing in operative diameter from the ratchet wheel's open ends toward the wheel's center, until the two centermost cavities meet. Thus, when secured in drive aperture 106 of wrench 100 (FIG. 1), ratchet wheel 112b allows use of the same wrench 100 with any of four differently sized fastener heads, provided sufficient clearance is provided below the fastener heads to permit cavities 114b and 114d to pass over fastener heads to be received by cavities 114a and 114c. Preferably, the wrench defines a second driving head on the opposite side of the wrench handle (as shown in FIGS. 3A-3C), and the second drive head receives a similar four-size ratchet wheel having four coaxial driving cavities defining respective operative diameters that are each different from each other and different from any of the operative diameters of the driving cavities 114a-114d of ratchet wheel 112b in the first driving head. Thus, the wrench can be used with any of eight differently sized fastener heads.

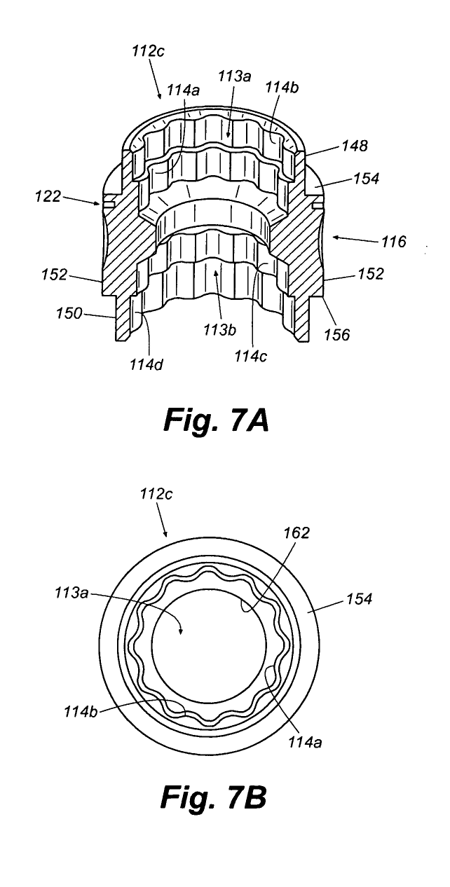

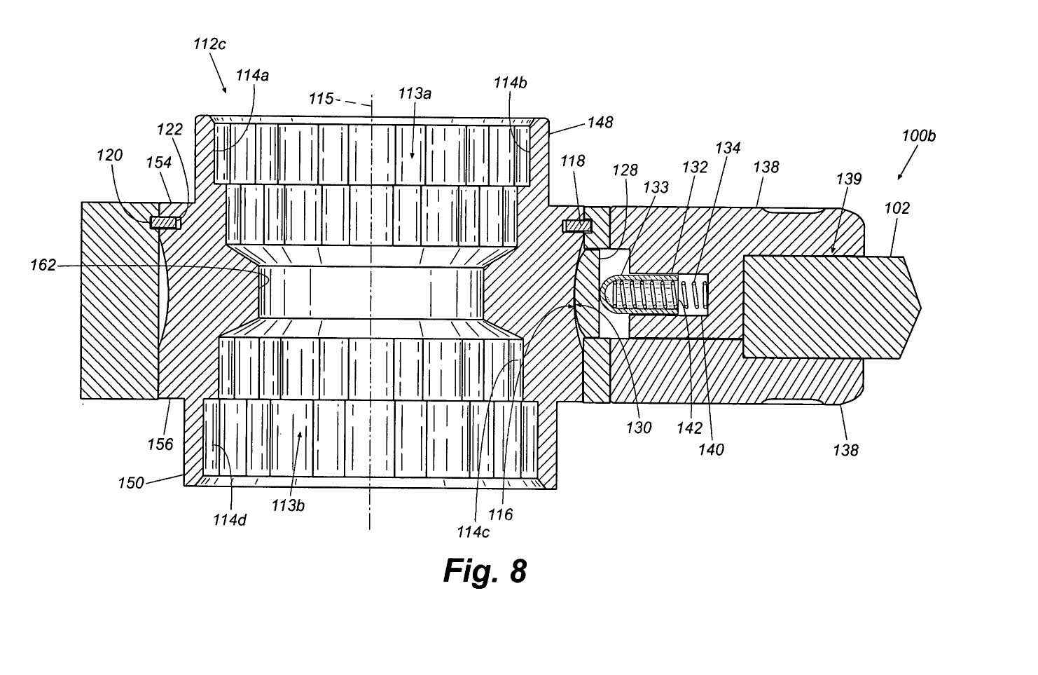

FIGS. 7A and 7B illustrate a ratchet wheel 112c for use with a ratchet wrench 100a (FIG. 8) in accordance with an embodiment of the present invention. Ratchet wheel 112c is similar in construction to that of ratchet wheel 112 shown in FIG. 2, with the exception that first and second drive cavities 114a and 114b are formed in first recess 113a, and third and fourth drive cavities 114c and 114d are formed in second recess 113b. As in the embodiment discussed above with respect to FIG. 6, each of cavities 114a through 114ddefines an operative diameter different from each other and different from the operative diameter of any fastener drive cavity defined in a ratchet wheel secured in the drive aperture on the opposite end of the wrench handle. Thus, the wrench can drive a number of differently sized fasteners equal to the number of differently sized cavities in the two ratchet wheels. FIG. 8 illustrates a ratchet wrench 100a including ratchet wheel 112c.

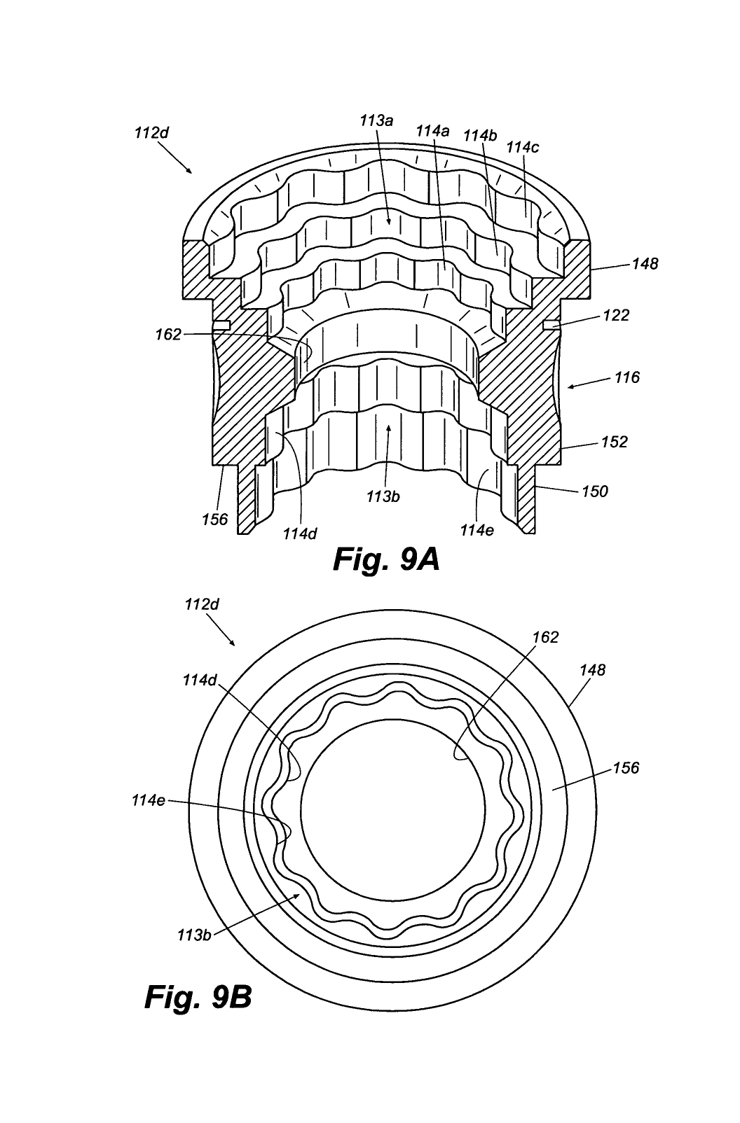

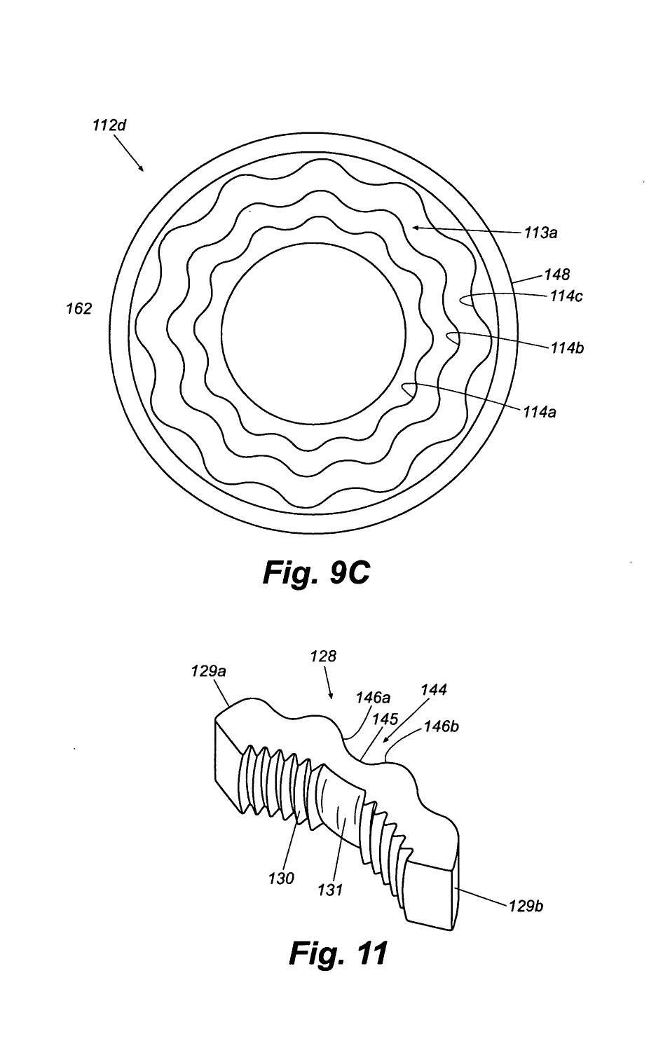

FIGS. 9A through 9C and 10 illustrate a ratchet wheel 112d for use in a ratchet wrench 100b in accordance with an embodiment of the present invention. Similar to ratchet wheel 112c shown in FIGS. 7A and 7B, ratchet wheel 112d includes first and second recesses 113a and 113b, each including multiple driving cavities 114a-114c and 113d through 114e, respectively. Unlike earlier described embodiments, however, ratchet wheel 112d includes a first end 148 that has a greatest outer diameter that is greater than the diameter of central portion 152. As such, the diameter of first end 148 is also greater than that of drive aperture 106, in which ratchet wheel 112d is rotatably received. This permits ratchet wheel 112d to include drive cavities in its first end 148 that also have a larger operative diameter than that of drive aperture 106. Each of cavities 114a through 114c has an operative diameter different from each other and from the operative diameter of any drive cavity of a ratchet wheel in a drive aperture on the opposite side of the wrench.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

In the claims:

1. A reversible ratchet wrench comprising:
a. a handle having a drive head at a first end thereof that defines a drive aperture therein;
b. a through bore located adjacent to the drive aperture;
c. a retaining recess intermediate and in communication with the drive aperture and the through bore;
d. a pawl defining a first plurality of drive teeth on a first side and being slidably received in the retaining recess, the pawl having a control recess formed in a second side;
e. a direction control lever mounted in the through bore and movable between a first predetermined position and a second predetermined position;
f. a pressing member having a longitudinal axis therethrough and mounted between the direction control lever and the control recess of the pawl; and
g. a ratchet wheel rotatably received in the drive aperture, the ratchet wheel including a first end having a first recess defining a first driving cavity, a second end having a second recess defining a second driving cavity, and a central portion disposed therebetween including a second plurality of drive teeth on an outer circumference thereof that engage the first plurality of drive teeth, a first inwardly depending ledge connecting the first end to the central portion, and a second inwardly depending ledge connecting the second end to the central portion, the first and second recesses forming a through hole along a longitudinal center axis of the ratchet wheel, wherein the first end of the ratchet wheel extends outwardly beyond a top surface of the drive head, the second end extends outwardly beyond a bottom surface of the drive head, the central portion of the ratchet wheel has an outer diameter that is greater than an outer diameter of the first end and an outer diameter of the second end, the first inwardly depending ledge and the top surface of the drive head lie in a first plane, and the second inwardly depending ledge and the bottom surface of the drive head lie in a second plane.

2. The reversible ratchet wrench of claim 1,
wherein an inner circumference of the ratchet wheel at the first driving cavity includes a plurality of spaced apart first drive shoulders aligned axially with respect to the drive aperture so that the first drive shoulders drivingly engage a workpiece of a first predetermined size that is inserted into the first driving cavity through the first recess
wherein the inner circumference of the ratchet wheel at the second driving cavity includes a plurality of spaced apart second drive shoulders aligned axially with respect to the drive aperture so that the second drive shoulders drivingly engage a workpiece of a second predetermined size that is inserted into the second driving cavity through the second recess, and
wherein each of the first and second predetermined sizes is different from each other of the first and second predetermined sizes.

3. The reversible ratchet wrench of claim 2,
wherein the first recess further defines a third driving cavity, the third driving cavity being disposed farther from a longitudinal center axis of the handle than the first driving cavity, and
wherein the inner circumference of the ratchet wheel at the third driving cavity includes a plurality of spaced apart third drive shoulders aligned axially with respect to the drive aperture so that the third drive shoulders drivingly engage a workpiece of a third predetermined size that is inserted into the third driving cavity through the first recess, and
wherein each of the first, second and third predetermined sizes is different from each other of the first, second and third predetermined sizes, and wherein the third predetermined size is larger than the first predetermined size.

4. The reversible ratchet wrench of claim 2, wherein a ledge depends inwardly from an inner wall of the through hole between the first and second driving cavities.

5. The reversible ratchet wrench of claim 3,
wherein the first recess further defines a fourth driving cavity, the fourth driving cavity being disposed farther from the longitudinal axis of the handle than the third driving cavity,
wherein the inner circumference of the ratchet wheel at the fourth driving cavity includes a plurality of spaced apart fourth drive shoulders aligned axially with respect to the drive aperture so that the fourth drive shoulders drivingly engage a workpiece of a fourth predetermined size that is inserted into the fourth driving cavity through the first recess, and
wherein each of the first, second, third and fourth predetermined sizes is different from each other of the first, second, third and fourth predetermined sizes, and
wherein the fourth predetermined size is larger than the third predetermined size

6. The reversible ratchet wrench of claim 3,
wherein the second recess further defines a fourth driving cavity, the fourth driving cavity being disposed farther from the longitudinal center axis of the handle than the second driving cavity,
wherein the inner circumference of the ratchet wheel at the fourth driving cavity includes a plurality of spaced apart fourth drive shoulders aligned axially with respect to the drive aperture so that the fourth drive shoulders drivingly engage a workpiece of a fourth predetermined size that is inserted into the fourth driving cavity through the second recess, and
wherein each of the first, second, third and fourth predetermined sizes is different from each other of the first, second, third and fourth predetermined sizes, and wherein the fourth predetermined size is larger than the second predetermined size.

7. The reversible ratchet wrench of claim 1, further comprising a biasing member intermediate the direction control lever and the pressing member.

8. The reversible ratchet wrench of claim 7, wherein the drive head defines a lever recess adjacent the through bore, the direction control lever includes a body portion received in the through bore and a hand actuatable handle portion extending from the body portion along the handle and disposed in the lever recess, the handle portion is movable within the lever recess such that the direction control lever is rotatable between the first and second predetermined positions, and engagement of the handle portion with the lever recess prevents rotation of the direction control lever to a position where the pressing member contacts the handle.

9. The reversible ratchet wrench of claim 7, wherein the biasing member is a spring, the pressing member is a detent pin, the drive head defines a first and a second lever recess adjacent the through bore, the direction control lever includes a first and a second hand actuatable handle portion extending outwardly the body portion along opposing sides of the handle, and the first handle portion is disposed in the first lever recess and the second handle portion is disposed in the second lever recess.

10. The reversible ratchet wrench of claim 1, further comprising:
a second drive aperture formed in a second end of the handle; and
a second ratchet wheel rotatably received in the second drive aperture, the second ratchet wheel having a first end defining a first driving cavity, a second end defining a second driving cavity, and a central portion disposed therebetween, the first end of the second ratchet wheel having an outer diameter that is larger than an outer diameter of the central portion of the second ratchet wheel and an outer diameter of the second end of the second ratchet wheel.

11. A reversible ratchet wrench comprising:
a. a handle having a drive head at a first end thereof that defines a drive aperture therein;
b. a through bore located adjacent to the drive aperture;
c. a retaining recess in communication with the drive aperture and the through bore;
d. a pawl including a first plurality of drive teeth on a first side and a control recess formed on a second side, the pawl being slidably received in the retaining recess;
e. a direction control lever mounted in the through bore and movable between a first predetermined position and a second predetermined position;
f. a detent pin reciprocally received in the direction control lever, the detent pin being biased into contact with the control recess of the pawl;
g. a ratchet wheel rotatably received in the drive aperture, the ratchet wheel including a first end having a first recess defining a first driving cavity and a second driving cavity, a second end having a second recess defining a third driving cavity, and a central portion disposed therebetween including a second plurality of drive teeth configured to engage the first plurality of drive teeth, the first and second recesses forming a through hole along a longitudinal center axis of the ratchet wheel, wherein the second driving cavity is disposed farther from a central longitudinal axis of the handle than is the first driving cavity;
h. wherein an inner circumference of the ratchet wheel at the first driving cavity includes a plurality of spaced apart first drive shoulders aligned axially with respect to the drive aperture so that the first drive shoulders drivingly engage a workpiece of a first predetermined size that is inserted into the first driving cavity through the first recess;
i. wherein the inner circumference of the ratchet wheel at the second driving cavity includes a plurality of spaced apart second drive shoulders aligned axially with respect to the drive aperture so that the second drive shoulders drivingly engage a workpiece of a second predetermined size that is inserted into the second driving cavity through the first recess;
j. wherein an inner circumference of the ratchet wheel at the third driving cavity includes a plurality of spaced apart third drive shoulders aligned axially with respect to the drive aperture so that the third drive shoulders drivingly engage a workpiece of a third predetermined size that is inserted into the third driving cavity through the second recess; and
k. wherein each of the first, second and third predetermined sizes is different from each other of the first, second and third predetermined sizes, and wherein the first predetermined size is smaller than the second predetermined size.

12. The reversible ratchet wrench of claim 11,
wherein the second recess further defines a fourth driving cavity, the fourth driving cavity being disposed farther from the longitudinal center axis of the handle than the third driving cavity,
wherein the inner circumference of the ratchet wheel at the fourth driving cavity includes a plurality of spaced apart fourth drive shoulders aligned axially with respect to the drive aperture so that the fourth drive shoulders drivingly engage a workpiece of a fourth predetermined size that is inserted into the fourth driving cavity through the second recess, and
wherein each of the first, second, third and fourth predetermined sizes is different from each other of the first, second, third and fourth predetermined sizes, and wherein the fourth predetermined size is larger than the third predetermined size.

13. The reversible ratchet wrench of claim 11, wherein the first end of the ratchet wheel extends outwardly beyond a top surface of the drive head and the second end of the ratchet wheel extends outwardly beyond a bottom surface of the drive head.

14. The reversible ratchet wrench of claim 13, wherein the central portion of the ratchet wheel has an outer diameter that is greater than an outer diameter of the first end and an outer diameter of the second end.

15. The reversible ratchet wrench of claim 11, wherein a ledge depends inwardly from an inner wall of the through hole between the first and third driving cavities.

16. The reversible ratchet wrench of claim 11, further comprising a spring intermediate the direction control lever and the detent pin.

17. The reversible ratchet wrench of claim 11, wherein the drive head defines a lever recess adjacent the through bore, the direction control lever includes a body portion received in the through bore and a hand actuatable handle portion extending from the body portion along the handle and disposed in the lever recess, the handle portion is movable within the lever recess such that the direction control lever is rotatable between the first and second predetermined positions, and engagement of the handle portion with the lever recess prevents rotation of the direction control lever to a position where the pressing member contacts the handle.

18. A reversible ratchet wrench comprising:
a. a handle having a drive head at a first end thereof that defines a drive aperture therein;
b. a bore located adjacent to the drive aperture;
c. a retaining recess in communication with the drive aperture and the bore;
d. a ratchet wheel rotatably disposed in the drive aperture and defining a plurality of first teeth about an outer circumference thereof;
e. a pawl including a first plurality of second teeth on a first side of the pawl and a control recess formed on a second side of the pawl, the control recess including a first end wall, a second end wall and a curved mediate portion therebetween, and the pawl being movably received in the retaining recess between a first position in which the first and second teeth are engaged on one side of the retaining recess and a second position in which the first teeth and second teeth are engaged on an opposite side of the retaining recess;
f. a direction control lever including a body portion received in the bore, a hand actuatable handle portion extending from the body portion, and a blind bore formed in the body portion, the direction control lever being movable in the bore between a third position and a fourth position;
g. wherein the direction control lever includes a detent pin coaxially and reciprocally received in the blind bore, the detent pin being biased into contact with the control recess of the pawl so that when the direction control lever is in the third position, the detent pin biases the pawl through the first end wall to the first position, and when the direction control lever is in the fourth position, the detent pin biases the pawl through the second end wall to the second position; and
h. wherein when the direction control lever is in either the third position or the fourth position, the pawl abuts the direction control lever between the direction control lever and the ratchet wheel so that the direction control lever inhibits rotation of the pawl away from the ratchet wheel in a direction perpendicular to the detent pin but allows movement of the pawl away from the ratchet wheel in a direction parallel to the detent pin.

19. The reversible ratchet wrench of claim 18, wherein when the direction control lever is in the third position, the second end wall abuts the direction control lever, and when the direction control lever is in the fourth position, the first end wall abuts the direction control lever.

20. The reversible ratchet wrench of claim 18, wherein the handle further comprises a lever recess having a first wall and a second wall, the lever recess pivotably receiving the handle portion such that the handle portion abuts the first wall when the direction control lever is in the third position and the handle portion abuts the second wall when the direction control member is in the fourth position.

21. A reversible ratchet wrench comprising:
an elongated handle formed of a solid homogeneous metal between a first end thereof and a second end thereof opposite the first end;
a first drive head extending from the first end of the handle and a second drive head extending from the second end of the handle, wherein each of the first drive head and the second drive head respectively defines a top surface, a bottom surface, and a first compartment, and wherein the handle respectively defines at each of the first end and second end a second compartment that opens to the first compartment and a third compartment that opens to the second compartment;
a first generally cylindrical ratchet wheel including a first end, a second end, and a central portion disposed therebetween, the first ratchet wheel being rotatably disposed in the first compartment of the first drive head and defining a plurality of first teeth about an outer circumference of the central portion thereof,
wherein the first ratchet wheel includes a first driving cavity that is defined by an inner circumference of the first ratchet wheel coaxially with the first compartment of the first drive head and that opens through the first end of the first ratchet wheel,
wherein the inner circumference of the first ratchet wheel at the first driving cavity includes a plurality of spaced apart first drive shoulders aligned axially with respect to the first compartment of the first drive head so that the first drive shoulders drivingly engage a workpiece of a first predetermined size that is inserted into the first driving cavity through the first end of the first ratchet wheel,
wherein the first ratchet wheel includes a second driving cavity that is defined by the inner circumference of the first ratchet wheel coaxially with the first compartment of the first drive head and that opens through the second end of the first ratchet wheel opposite the first end of the first ratchet wheel,
wherein the inner circumference of the first ratchet wheel at the second driving cavity includes a plurality of spaced apart second drive shoulders aligned axially with respect to the first compartment of the first drive head so that the second drive shoulders drivingly engage a workpiece of a second predetermined size that is inserted into the second driving cavity through the second end of the first ratchet wheels,
wherein the central portion of the first ratchet wheel includes a first inwardly depending ledge connecting the first end to the central portion, and a second inwardly depending ledge connecting the second end to the central portion,
wherein the first inwardly depending ledge and the top surface of the drive head lie in a first plane, and the second inwardly depending ledge and the bottom surface of the drive head lie in a second plane,
a second ratchet wheel rotatably disposed in the first compartment of the second drive head and defining a plurality of second teeth about an outer circumference thereof,
wherein the second ratchet wheel includes a third driving cavity that is defined by an inner circumference of the second ratchet wheel coaxially with the first compartment of the second drive head and that opens through a first end of the second ratchet wheel,
wherein the inner circumference of the second ratchet wheel at the third driving cavity includes a plurality of spaced apart third drive shoulders aligned axially with respect to the first compartment of the second drive head so that the third drive shoulders drivingly engage a workpiece of a third predetermined size that is inserted into the third driving cavity through the first end of the second ratchet wheel,
wherein the second ratchet wheel includes a fourth driving cavity that is defined by the inner circumference of the second ratchet wheel coaxially with the first compartment of the second drive head and that opens through a second end of the second ratchet wheel opposite the first end of the second ratchet wheel, and
wherein the inner circumference of the second ratchet wheel at the fourth driving cavity includes a plurality of spaced apart fourth drive shoulders aligned axially with respect to the first compartment of the second drive head so that the fourth drive shoulders drivingly engage a workpiece of a fourth predetermined size that is inserted into the fourth driving cavity through the second end of the second ratchet wheel;
a first pawl disposed in the second compartment at the first end of the handle
wherein the first pawl has a front side that faces the first teeth and that has a plurality of third teeth, and
wherein the first pawl is movable within the second compartment at the first end of the handle between a first position in which the first teeth and the third teeth are engaged on one side of the second compartment at the first end of the handle and a second position in which the first teeth and the third teeth are engaged on an opposite side of the second compartment at the first end of the handle;
a first lever having
a first hand actuatable outer portion and
a second inner portion received by the third compartment at the first end of the handle in driving engagement with the first pawl, wherein the first lever is disposed movably with respect to the first end of the handle so that a movement of the first hand actuatable portion with respect to the first end of the handle drives the first pawl from one of the first position and the second position to the other of the first position and the second position;
a second pawl disposed in the second compartment at the second end of the handle
wherein the second pawl has a front side that faces the second teeth and that has a plurality of fourth teeth, and
wherein the second pawl is movable within the second compartment at the second end of the handle between a third position in which the second teeth and the fourth teeth are engaged on one side of the second compartment at the second end of the handle and a fourth position in which the second teeth and the fourth teeth are engaged on an opposite side of the second compartment at the second end of the handle;
a second lever having
a second hand actuatable outer portion and
a second inner portion received by the third compartment at the second end of the handle in driving engagement with the second pawl, wherein the second lever is disposed movably with respect to the second end of the handle so that a movement of the second hand actuatable portion with respect to the second end of the handle drives the second pawl from one of the third position and the fourth position to the other of the third position and the fourth position; and
wherein each of the first, second, third and fourth predetermined sizes is different from each other of the first, second, third and fourth predetermined sizes.

22. A reversible ratchet wrench comprising:
an elongated handle having a first end thereof and a second end thereof opposite the first end;
a first drive head extending from the first end of the handle and a second drive head extending from the second end of the handle, wherein each of the first drive head and the second drive head respectively defines a first compartment, and wherein the handle respectively defines at each of the first end and second end a second compartment that opens to the first compartment and a third compartment that opens to the second compartment;
a first generally cylindrical ratchet wheel rotatably disposed in the first compartment of the first drive head and defining a plurality of first teeth about an outer circumference thereof,
wherein the first ratchet wheel includes a first driving cavity that is defined by an inner circumference of the first ratchet wheel coaxially with the first compartment of the first drive head and that opens through a first end of the first ratchet wheel,
wherein the inner circumference of the first ratchet wheel at the first driving cavity includes a plurality of spaced apart first drive shoulders aligned axially with respect to the first compartment of the first drive head so that the first drive shoulders drivingly engage a workpiece of a first predetermined size that is inserted into the first driving cavity through the first end of the first ratchet wheel,
wherein the first ratchet wheel includes a second driving cavity that is defined by the inner circumference of the first ratchet wheel coaxially with the first compartment of the first drive head and that opens through a second end of the first ratchet wheel opposite the first end of the first ratchet wheel,
wherein the inner circumference of the first ratchet wheel at the second driving cavity includes a plurality of spaced apart second drive shoulders aligned axially with respect to the first compartment of the first drive head so that the second drive shoulders drivingly engage a workpiece of a second predetermined size that is inserted into the second driving cavity through the second end of the first ratchet wheel,
wherein the first ratchet wheel includes a third driving cavity that is defined by the inner circumference of the first ratchet wheel coaxially with the first compartment of the first drive head between the first driving cavity and the second driving cavity, and
wherein the inner circumference of the first ratchet wheel at the third driving cavity includes a plurality of spaced apart third drive shoulders aligned axially with respect to the first compartment of the first drive head so that the third drive shoulders drivingly engage a workpiece of a third predetermined size that is inserted into the third driving cavity through the first end of the first ratchet wheel;
a second ratchet wheel rotatably disposed in the first compartment of the second drive head and defining a plurality of second teeth about an outer circumference thereof,
wherein the second ratchet wheel includes a fourth driving cavity that is defined by an inner circumference of the second ratchet wheel coaxially with the first compartment of the second drive head and that opens through a first end of the second ratchet wheel,
wherein the inner circumference of the second ratchet wheel at the fourth driving cavity includes a plurality of spaced apart fourth drive shoulders aligned axially with respect to the first compartment of the second drive head so that the fourth drive shoulders drivingly engage a workpiece of a fourth predetermined size that is inserted into the fourth driving cavity through the first end of the second ratchet wheel,
wherein the second ratchet wheel includes a fifth driving cavity that is defined by the inner circumference of the second ratchet wheel coaxially with the first compartment of the second drive head and that opens through a second end of the second ratchet wheel opposite the first end of the second ratchet wheel, and
wherein the inner circumference of the second ratchet wheel at the fifth driving cavity includes a plurality of spaced apart fifth drive shoulders aligned axially with respect to the first compartment of the second drive head so that the fifth drive shoulders drivingly engage a workpiece of a fifth predetermined size that is inserted into the fifth driving cavity through the second end of the second ratchet wheel;
a first pawl disposed in the second compartment at the first end of the handle
wherein the first pawl has a front side that faces the first teeth and that has a plurality of third teeth, and
wherein the first pawl is movable within the second compartment at the first end of the handle between a first position in which the first teeth and the third teeth are engaged on one side of the second compartment at the first end of the handle and a second position in which the first teeth and the third teeth are engaged on an opposite side of the second compartment at the first end of the handle;
a first lever having
a first hand actuatable outer portion and
a second inner portion received by the third compartment at the first end of the handle in driving engagement with the first pawl, wherein the first lever is disposed movably with respect to the first end of the handle so that a movement of the first hand actuatable portion with respect to the first end of the handle drives the first pawl from one of the first position and the second position to the other of the first position and the second position;
a second pawl disposed in the second compartment at the second end of the handle
wherein the second pawl has a front side that faces the second teeth and that has a plurality of fourth teeth, and
wherein the second pawl is movable within the second compartment at the second end of the handle between a third position in which the second teeth and the fourth teeth are engaged on one side of the second compartment at the second end of the handle and a fourth position in which the second teeth and the fourth teeth are engaged on an opposite side of the second compartment at the second end of the handle;
a second lever having
a second hand actuatable outer portion and
a second inner portion received by the third compartment at the second end of the handle in driving engagement with the second pawl, wherein the second lever is disposed movably with respect to the second end of the handle so that a movement of the second hand actuatable portion with respect to the second end of the handle drives the second pawl from one of the third position and the fourth position to the other of the third position and the fourth position; and
wherein each of the first, second, third, fourth and fifth predetermined sizes is different from each other of the first, second, third, fourth and fifth predetermined sizes, and wherein the third predetermined size is smaller than the first predetermined size.

23. The reversible ratchet wrench of claim 22,
wherein the first ratchet wheel includes a sixth driving cavity that is defined by the inner circumference of the first ratchet wheel coaxially with the first compartment of the first drive head between the third driving cavity and the second driving cavity,
wherein the inner circumference of the first ratchet wheel at the sixth driving cavity includes a plurality of spaced apart sixth drive shoulders aligned axially with respect to the first compartment of the first drive head so that the sixth drive shoulders drivingly engage a workpiece of a sixth predetermined size that is inserted into the sixth driving cavity through the second end of the first ratchet wheel, and
wherein each of the first, second, third, fourth, fifth and sixth predetermined sizes is different from each other of the first, second, third, fourth, fifth and sixth predetermined sizes, and wherein the sixth predetermined size is smaller than the second predetermined size.24. The reversible ratchet wrench of claim 23,

24. The reversible ratchet wrench of claim 23,
wherein the second ratchet wheel includes a seventh driving cavity that is defined by the inner circumference of the second ratchet wheel coaxially with the first compartment of the second drive head between the fourth driving cavity and the fifth driving cavity,
wherein the inner circumference of the first ratchet wheel at the seventh driving cavity includes a plurality of spaced apart seventh drive shoulders aligned axially with respect to the first compartment of the second drive head so that the seventh drive shoulders drivingly engage a workpiece of a seventh predetermined size that is inserted into the seventh driving cavity through the first end of the second ratchet wheel, and
wherein each of the first, second, third, fourth, fifth, sixth and seventh predetermined sizes is different from each other of the first, second, third, fourth, fifth, sixth and seventh predetermined sizes, and wherein the seventh predetermined size is smaller than the fourth predetermined size.

25. The reversible ratchet wrench of claim 22,
wherein the second ratchet wheel includes an eighth driving cavity that is defined by the inner circumference of the second ratchet wheel coaxially with the first compartment of the second drive head between the seventh driving cavity and the fifth driving cavity,
wherein the inner circumference of the first ratchet wheel at the eighth driving cavity includes a plurality of spaced apart eighth drive shoulders aligned axially with respect to the first compartment of the second drive head so that the eighth drive shoulders drivingly engage a workpiece of an eighth predetermined size that is inserted into the eighth driving cavity through the second end of the second ratchet wheel, and
wherein each of the first, second, third, fourth, fifth, sixth, seventh and eighth predetermined sizes is different from each other of the first, second, third, fourth, fifth, sixth, seventh and eighth predetermined sizes, and wherein the eighth predetermined size is smaller than the fifth predetermined size.
